(19) United States
(12) Patent Application Publication
(10) Pub. No.: US 2017/0277622 A1
(43) Pub. Date: Sep. 28, 2017

(54) Web Page Automated Testing Method and Apparatus

(71) Applicant: HUAWEI TECHNOLOGIES CO., LTD., Shenzhen (CN)

(72) Inventor: Xudong Gao, Nanjing (CN)

(21) Appl. No.: 15/508,648

(22) PCT Filed: Sep. 3, 2014
(86) PCT No.: PCT/CN2014/085876

§ 371 Date: Mar. 3, 2017

(51) Int. Cl. G06F 11/36; H04L 29/08; G06F 17/30

(52) U.S. Cl. CPC G06F 11/3664; G06F 17/30864; G06F 17/3089; H04L 67/02; H04L 67/28

(57) ABSTRACT

A web page automated testing method and apparatus. In the web page automated testing method, target network interaction data sent by a browser to a server is obtained using a network proxy server. Then, a web page automated testing tool validates the target network interaction data, thereby implementing validation on network interaction data between the browser or a web page and the server. A network request in the target network interaction data is validated, which improves a capability of finding a web page defect, and a response message returned by the server is validated, which improves accuracy of a web page display validation result.

### CROSS-REFERENCE TO RELATED APPLICATIONS

This application is a U.S. National Stage of International Patent Application No. PCT/CN2014/085876 filed Sep. 3, 2014, which is hereby incorporated by reference in its entirety.

### TECHNICAL FIELD

The present disclosure relates to the field of web page testing technologies, and in particular, to a web page automated testing method and apparatus.

### BACKGROUND

A web page is an important platform for network information exchange. Content and a function carried by the web page are characterized by diversity and uncertainty, and this requires the content of the web page to be designed according to different application requirements and network environments. To ensure reliability of web page performance, a test needs to be performed on a designed web page.

Web page automated testing is automated verification on input and output of a web page being tested. Currently, web page automated testing work is completed using a web page automated testing tool, and an operating principle of the web page automated testing tool is recording and playback. The recording means recording an operation of a user on a browser and a web page by time and forming an identifiable script, using the web page automated testing tool. The playback means that the web page automated testing tool reads a previously recorded script, and performs an operation on the browser and the web page by simulating a previous behavior of the user. It may be learned according to the foregoing testing procedure that the operation of the user on the browser and the web page is input, and an operation result is output. In addition, the operation result also changes with content of the web page. Therefore, the web page automated testing is simulating user input and verifying output, that is, verifying an input operation result.

In a specific network environment, the user generally operates the web page using the browser on a network terminal, and the content and the function of the web page need to be supported by a server. Therefore, data interaction between the browser and the server is also a part of input and output of the web page. A network request sent by the browser to the server is output, and a response fed back by the server is input. Such an interaction process affects a web page display result, and is also a part of the test. However, according to a current web page automated testing method, only an operation of the user performed on the web page using the browser is recorded, an operation between the browser or the web page and the server cannot be recorded, and the response of the server cannot be verified.

Lacking validation on the network request inevitably leads to a relatively low capability of finding a web page defect, and even incapability of finding a part of defects. For example, when the user enters a character “abc” in a search box of the web page, and then clicks a search button of the web page, a search character in a network request sent by the web page is “abc+space”, and the web page finally displays search content obtained by searching for “abc+space”, where a range of the search content is extremely smaller than a range of search content obtained by searching for “abc”. This type of problem cannot be found in the current web page automated testing method. Lacking validation on a response message fed back by the server inevitably leads to lower accuracy of a web page display validation result, and even some web pages cannot be validated because of a lack of determining basis.

In conclusion, in the current web page automated testing method, a capability of finding a web page defect is relatively low, and accuracy of a web page display validation result is low.

### SUMMARY

Embodiments of the present disclosure provide a web page automated testing method and apparatus in order to resolve a problem in the prior art that a capability of finding a web page defect is low, and accuracy of a web page display validation result is low.

To resolve the foregoing technical problem, the embodiments of the present disclosure disclose the following technical solutions.

According to a first aspect, the present disclosure provides a web page automated testing method, including obtaining, by a terminal, target network interaction data between the terminal and a server, where the target network interaction data includes a network request sent by the terminal to the server, and a response message that is received by the terminal and is returned by the server, where the response message is a response of the server to the network request sent by the terminal, and validating, by the terminal, the target network interaction data.

With reference to the first aspect, in a first possible implementation manner of the first aspect, obtaining, by a terminal, target network interaction data between the terminal and a server includes obtaining, by the terminal, specified network interaction data from network interaction data that is obtained by the terminal and is between the terminal and the server, where the specified network interaction data is network interaction data that includes a filter keyword, and obtaining, by the terminal from the specified network interaction data, network interaction data that includes a query keyword in order to obtain the target network interaction data, where the query keyword includes a character of the filter keyword.

With reference to the first aspect, in a second possible implementation manner of the first aspect, obtaining, by a terminal, target network interaction data between the terminal and a server includes obtaining, by the terminal from network interaction data that is obtained by the terminal and is between the terminal and the server, network interaction data that includes the query keyword in order to obtain the target network interaction data.

With reference to the first aspect, in a third possible implementation manner of the first aspect, obtaining, by a terminal, target network interaction data between the terminal and a server includes sending, by the terminal, a filter keyword to the server, where the filter keyword is used to enable the server to obtain specified network interaction data from obtained network interaction data between the terminal and the server, where the specified network interaction data is network interaction data that includes the filter keyword, sending, by the terminal, a query keyword to the server, where the query keyword is used to enable the server to obtain the target network interaction data from the specified network interaction network interaction data is network interaction data that includes the query keyword, and the query keyword includes at least a character of the filter keyword, and receiving, by the terminal, the target network interaction data sent by the server.

With reference to the first aspect, in a fourth possible implementation manner of the first aspect, obtaining, by a terminal, target network interaction data between the terminal and a server includes sending, by the terminal, a query keyword to the server, where the query keyword is used to enable the server to acquire the target network interaction data from obtained network interaction data between the terminal and the server, where the target network interaction data is network interaction data that includes the query keyword, and receiving, by the terminal, the target network interaction data sent by the server.

According to a second aspect, the present disclosure further provides a web page automated testing method, including obtaining, by a server, target network interaction data between the server and a terminal, where the target network interaction data includes a network request that is received by the server and is sent by the terminal, and a response message sent by the server to the terminal, where the response message is a response of the server to the network request sent by the terminal, and sending, by the server, the target network interaction data to the terminal, where the target network interaction data is used by the terminal to validate the target network interaction data.

With reference to the second aspect, in a first possible implementation manner of the second aspect, obtaining, by a server, target network interaction data between the server and a terminal includes receiving, by the server, a query keyword sent by the terminal, and obtaining, by the server, the target network interaction data from obtained network interaction data between the server and the terminal, where the target network interaction data is network interaction data that includes the query keyword.

With reference to the second aspect, in a second possible implementation manner of the second aspect, obtaining, by a server, target network interaction data between the server and a terminal includes receiving, by the server, a filter keyword sent by the terminal, obtaining, by the server, specified network interaction data from obtained network interaction data between the server and the terminal, where the specified network interaction data is network interaction data that includes the filter keyword, receiving, by the server, a query keyword sent by the terminal, where the query keyword includes a character of the filter keyword, and obtaining, by the server, the target network interaction data from the specified network interaction data, where the target network interaction data is network interaction data that includes the query keyword.

According to a third aspect, the present disclosure provides a web page automated testing apparatus, applied to a terminal, where the apparatus includes an obtaining unit configured to obtain target network interaction data between the terminal and a server, where the target network interaction data includes a network request sent by the terminal to the server, and a response message that is received by the terminal and is returned by the server, where the response message is a response of the server to the network request sent by the terminal, and a validation unit configured to validate the target network interaction data obtained by the obtaining unit.

With reference to the third aspect, in a first possible implementation manner of the third aspect, the obtaining unit includes a first obtaining subunit configured to obtain specified network interaction data from obtained network interaction data between the terminal and the server, where the specified network interaction data is network interaction data that includes a filter keyword, and a second obtaining subunit configured to obtain, from the specified network interaction data obtained by the first obtaining subunit, network interaction data that includes a query keyword in order to obtain the target network interaction data, where the query keyword includes a character of the filter keyword.

With reference to the third aspect, in a second possible implementation manner of the third aspect, the obtaining unit includes a third obtaining subunit configured to obtain, from obtained network interaction data between the terminal and the server, network interaction data that includes the query keyword in order to obtain the target network interaction data.

With reference to the third aspect, in a third possible implementation manner of the third aspect, the obtaining unit includes a sending subunit and a receiving subunit, where the sending subunit is configured to send a filter keyword to the server, where the filter keyword enables the server to obtain specified network interaction data from obtained network interaction data between the terminal and the server, where the specified network interaction data is network interaction data that includes the filter keyword. The sending subunit is further configured to send a query keyword to the server, where the query keyword enables the server to obtain the target network interaction data from the specified network interaction data, where the target network interaction data is network interaction data that includes the query keyword, and the query keyword includes at least a character of the filter keyword, and the receiving subunit is configured to receive the target network interaction data sent by the server.

With reference to the third aspect, in a fourth possible implementation manner of the third aspect, the obtaining unit includes a sending subunit and a receiving subunit, where the sending subunit is configured to send a query keyword to the server, where the query keyword enables the server to obtain the target network interaction data from obtained network interaction data between the terminal and the server, where the target network interaction data is network interaction data that includes the query keyword, and the receiving subunit is configured to receive the target network interaction data sent by the server.

According to a fourth aspect, the present disclosure further provides a terminal, including a processor configured to obtain target network interaction data between the terminal and a server, where the target network interaction data includes a network request sent by the terminal to the server, and a response message that is received by the terminal and is returned by the server, where the response message is a response of the server to the network request sent by the terminal, where the processor is further configured to validate the target network interaction data.

With reference to the fourth aspect, in a first possible implementation manner of the fourth aspect, the processor is further configured to obtain specified network interaction data from network interaction data that is obtained by the terminal and is between the terminal and the server, where the specified network interaction data is network interaction data that includes a filter keyword, and obtain, from the specified network interaction data, network interaction data that includes a query keyword in order to obtain the target network interaction data, where the query keyword includes a character of the filter keyword.

With reference to the fourth aspect, in a second possible implementation manner of the fourth aspect, the processor is further configured to obtain, from network interaction data that is obtained by the terminal and is between the terminal and the server, network interaction data that includes the query keyword in order to obtain the target network interaction data.

With reference to the fourth aspect, in a third possible implementation manner of the fourth aspect, the terminal further includes a transmitter and a receiver, where the transmitter is connected to the processor, and the receiver is connected to the processor. The transmitter is configured to send a filter keyword to the server, where the filter keyword enables the server to obtain specified network interaction data from obtained network interaction data between the terminal and the server, where the specified network interaction data is network interaction data that includes the filter keyword. The transmitter is further configured to send a query keyword to the server, where the query keyword enables the server to obtain the target network interaction data from the specified network interaction data, where the target network interaction data is network interaction data that includes the query keyword, and the query keyword includes at least a character of the filter keyword, and the receiver is configured to receive the target network interaction data sent by the server, and send the target network interaction data to the processor.

With reference to the fourth aspect, in a fourth possible implementation manner of the fourth aspect, the terminal further includes a transmitter and a receiver, where the transmitter is connected to the processor, and the receiver is connected to the processor. The transmitter is configured to send a query keyword to the server, where the query keyword enables the server to obtain the target network interaction data from obtained network interaction data between the terminal and the server, where the target network interaction data is network interaction data that includes the query keyword, and the receiver is configured to receive the target network interaction data sent by the server, and provide the target network interaction data for the processor.

According to a fifth aspect, the present disclosure provides a web page automated testing apparatus, including an obtaining unit configured to obtain target network interaction data between a server and a terminal, where the target network interaction data includes a network request that is received by the server and is sent by the terminal, and a response message sent by the server to the terminal, where the response message is a response of the server to the network request sent by the terminal, and a sending unit configured to send the target network interaction data obtained by the obtaining unit to the terminal, where the target network interaction data is used by the terminal to validate the target network interaction data.

With reference to the fifth aspect, in a first possible implementation manner of the fifth aspect, the obtaining unit includes a receiving subunit and an obtaining subunit, where the receiving subunit is configured to receive a query keyword sent by the terminal, and the obtaining subunit is configured to obtain the target network interaction data from obtained network interaction data between the server and the terminal, where the target network interaction data is network interaction data that includes the query keyword received by the receiving subunit.

With reference to the fifth aspect, in a second possible implementation manner of the fifth aspect, the obtaining unit includes a receiving subunit and an obtaining subunit, where the receiving subunit is configured to receive a filter keyword sent by the terminal. The obtaining subunit is configured to obtain specified network interaction data from obtained network interaction data between the server and the terminal, where the specified network interaction data is network interaction data that includes the filter keyword received by the receiving subunit. The receiving subunit is further configured to receive a query keyword sent by the terminal, where the query keyword includes a character of the filter keyword, and the obtaining subunit is further configured to obtain the target network interaction data from the specified network interaction data, where the target network interaction data is network interaction data that includes the query keyword received by the receiving subunit.

According to a sixth aspect, the present disclosure provides a server, including a processor and a transmitter, where the transmitter is connected to the processor. The processor is configured to obtain target network interaction data between the server and a terminal, where the target network interaction data includes a network request that is received by the server and is sent by the terminal, and a response message sent by the server to the terminal, where the response message is a response of the server to the network request sent by the terminal, and the transmitter is configured to send the target network interaction data obtained by the processor to the terminal, where the target network interaction data is used by the terminal to validate the target network interaction data.

With reference to the sixth aspect, in a first possible implementation manner of the sixth aspect, the server further includes a receiver, where the receiver is connected to the processor. The receiver is configured to receive a query keyword sent by the terminal, and the processor is further configured to obtain the target network interaction data from obtained network interaction data between the server and the terminal, where the target network interaction data is network interaction data that includes the query keyword sent by the receiver.

With reference to the sixth aspect, in a second possible implementation manner of the sixth aspect, the server further includes a receiver, where the receiver is connected to the processor. The receiver is configured to receive a filter keyword sent by the terminal. The processor is further configured to obtain specified network interaction data from obtained network interaction data between the server and the terminal, where the specified network interaction data is network interaction data that includes the filter keyword sent by the receiver. The receiver is further configured to receive a query keyword sent by the terminal, where the query keyword includes a character of the filter keyword, and the processor is further configured to obtain the target network interaction data from the specified network interaction data, where the target network interaction data is network interaction data that includes the query keyword sent by the receiver.

According to a seventh aspect, the present disclosure further provides a computer storage medium, where the computer storage medium may store a program, and when the program is executed, a step according to any one of the possible implementation manners of the first aspect is performed.

According to an eighth aspect, the present disclosure further provides a computer storage medium, where the computer storage medium may store a program, and when the program is executed, a step according to any one of the possible implementation manners of the second aspect is performed.

It may be learned from the foregoing technical solutions that, in the web page automated testing method provided in the embodiments of the present disclosure, a terminal obtains specified network interaction data between a browser inside the terminal and a server. Then, target network interaction data is determined from the specified network interaction data, a parameter of a network request in the target network interaction data is resolved, and whether a network request sent by the terminal is accurate is validated, which improves a capacity of finding a web page defect. In addition, a parameter of a response message returned by the server is resolved, and whether content displayed on a web page of the browser is accurate is validated, which improves accuracy of a web page display validation result.

### BRIEF DESCRIPTION OF DRAWINGS

Drawings of the specification that constitute a part of the present application are used to provide further understanding of the present disclosure, and schematic embodiments of the present disclosure and descriptions thereof are used to explain the present disclosure, which do not constitute an improper limitation to the present disclosure.

FIG. 1 shows a block diagram of a network proxy server according to an embodiment of the present disclosure;

FIG. 2 shows a schematic flowchart of a web page automated testing method according to an embodiment of the present disclosure;

FIG. 3 shows a schematic flowchart of a method of step S110 in FIG. 2 according to an embodiment of the present disclosure;

FIG. 4 shows another schematic flowchart of a method of step S110 in FIG. 2 according to an embodiment of the present disclosure;

FIG. 5 shows still another schematic flowchart of a method of step S110 in FIG. 2 according to an embodiment of the present disclosure;

FIG. 6 shows a schematic flowchart of another web page automated testing method according to an embodiment of the present disclosure;

FIG. 7 shows a schematic flowchart of still another web page automated testing method according to an embodiment of the present disclosure;

FIG. 8A and FIG. 8B are a schematic flowchart of yet another web page automated testing method according to an embodiment of the present disclosure;

FIG. 9 shows a schematic structural diagram of a web page automated testing apparatus according to an embodiment of the present disclosure;

FIG. 10 shows a schematic structural diagram of another web page automated testing apparatus according to an embodiment of the present disclosure;

FIG. 11 shows a schematic structural diagram of a terminal according to an embodiment of the present disclosure;

FIG. 12 shows a schematic structural diagram of another terminal according to an embodiment of the present disclosure;

FIG. 13 shows a schematic structural diagram of a server according to an embodiment of the present disclosure; and

FIG. 14 shows a schematic structural diagram of a server according to an embodiment of the present disclosure.

To describe the technical solutions in the embodiments of the present disclosure more clearly, the following briefly introduces the accompanying drawings required for describing the embodiments. A person of ordinary skill in the art may still derive other drawings from these accompanying drawings without creative efforts.

### DESCRIPTION OF EMBODIMENTS

To make a person skilled in the art understand the technical solutions in the present disclosure better, the following clearly and completely describes the technical solutions in the embodiments of the present disclosure with reference to the accompanying drawings in the embodiments of the present disclosure. The described embodiments are merely a part rather than all of the embodiments of the present disclosure. All other embodiments obtained by a person of ordinary skill in the art based on the embodiments of the present disclosure without creative efforts shall fall within the protection scope of the present disclosure.

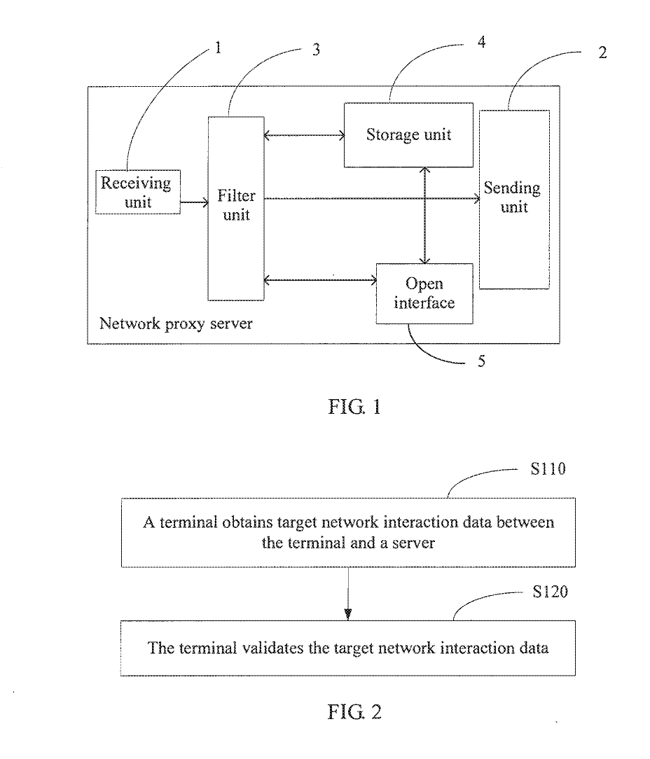

Referring to FIG. 1, FIG. 1 shows a block diagram of a network proxy server according to an embodiment of the present application. As shown in FIG. 1, different from a conventional network proxy server, in addition to a receiving unit 1 and a sending unit 2, the network proxy server includes a filter unit 3, a storage unit 4, and an open interface 5.

The filter unit 3 has a function of performing initial filtering on network interaction data. A browser generates many requests in a process of loading a web page, for example, a request for a cascading style sheet (CSS), JAVASCRIPT (JS), a picture, music, and service data (for example, data included in a table of the web page). The network proxy server needs to store a network request and a response message that are concerned by a web page test engineer. Further, the network request and the response message may be obtained by means of filtering by the filter unit 3. The storage unit 4 is configured to store the network request and the response message, and provide the network request and the response message for a web page automated testing tool through the open interface 5.

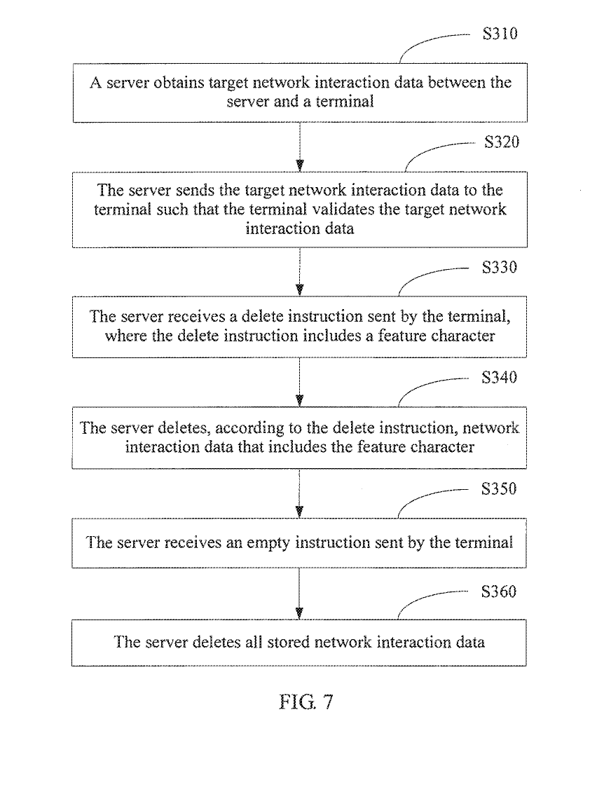

Referring to FIG. 2, FIG. 2 shows a schematic flowchart of a web page automated testing method according to an embodiment of the present disclosure. This method is applied to a terminal. The terminal may be a terminal device using which a web page can be browsed, such as a personal computer (PC), a notebook computer, a tablet computer, and a smartphone.

The terminal in this embodiment is integrated with a web page automated testing tool. The network proxy server shown in FIG. 1 obtains network interaction data between the terminal and a server, and then provides the network interaction data for the web page automated testing tool. Finally, the web page automated testing tool validates the network interaction data.

As shown in FIG. 2, the method includes the following steps.

Step S110: The terminal obtains target network interaction data between the terminal and the server.

The target network interaction data includes a network request sent by the terminal to the server, and a response message that is received by the terminal and is returned by the server. The response message is a response of the server to the network request sent by the terminal.

The web page automated testing tool in the terminal enables the network proxy server, then invokes the browser, and sets an address of the network proxy server for the browser. The web page automated testing tool operates the browser, and the browser sends a corresponding network request using the terminal. The network proxy server receives the network request, and forwards the network request to the server. After receiving a response message returned by the server in response to the network request, when sending the response message to the browser, the network proxy server replicates and stores the target network interaction data between the terminal and the server.

When the network proxy server is integrated into the web page automated testing tool, the web page automated testing tool enables the network proxy server in an initialization manner. When the network proxy server is integrated into another software of the terminal, the network automated testing tool enables the network proxy server using a start command.

Network interaction data that a network engineer actually wants to test may be only a specific type of network interaction data in the network interaction data between the terminal and the server. Therefore, the terminal only needs to obtain the network interaction data that the web page test engineer actually wants to test.

For example, the web page test engineer sets one or more query keywords using the web page automated testing tool in the terminal, and transfers the query keyword to the network proxy server through an open interface of the network proxy server. The network proxy server obtains the target network interaction data from obtained network interaction data between the terminal and the server. The target network interaction data is network interaction data that includes the query keyword.

Step S120: The terminal validates the target network interaction data.

After obtaining the target network interaction data, the web page automated testing tool determines whether an operation on the browser or the web page is consistent with a parameter in the network request. It indicates that a network request sent by the browser or the web page is accurate if the parameters are consistent, and it indicates that the network request sent by the browser or the web page is inaccurate if the parameters are inconsistent. For example, when a user enters a character “abc” in a search field of a web page, a network request sent by the terminal to the server is obtained, and it is determined whether the network request is consistent with an operation of the user on the web page. The web page automated testing tool resolves a response message, and determines whether a message obtained by means of resolution is consistent with content displayed on the web page in order to validate accuracy of the content displayed on the web page.

In the web page automated testing method provided in this embodiment, a terminal obtains target network interaction data between the terminal and a server using a network proxy server, validates a network request in the target network interaction data using a web page automated testing tool in order to improve a capability of finding a web page defect, and validates a response message returned by the server in order to improve accuracy of a web page display validation result.

In an embodiment provided by the present disclosure, according to different integration locations of the network proxy server, a specific process of step S110 that the terminal obtains target network interaction data between the terminal and the server in FIG. 2 may be classified into the following two types.

(1) The network proxy server is integrated on a terminal side.

Referring to FIG. 3, FIG. 3 shows a schematic flowchart of a method for obtaining target network interaction data according to an embodiment of the present disclosure. This method is applied to a terminal, and in this method, the target network interaction data is obtained using a filter keyword and a query keyword. As shown in FIG. 3, the method includes the following steps.

Step S1111: Obtain specified network interaction data from network interaction data obtained by the terminal, where the specified network interaction data is network interaction data that includes a filter keyword.

A network proxy server obtains, from received network interaction data between the terminal and a server by means of filtering, the network interaction data that includes the filter keyword in order to obtain the specified network interaction data.

A network test engineer may set one or more filter keywords using a web page automated testing tool, and transfer the filter keyword to the network proxy server through an open interface of the network proxy server. The network proxy server obtains only network interaction data that includes the filter keyword in order to obtain specified network interaction data. That is, the specified network interaction data is a part of the network interaction data between the terminal and the server.

The network proxy server determines whether the received network interaction data between the terminal and the server includes the filter keyword. The network interaction data that includes the filter keyword is replicated and stored in a storage unit if the received network interaction data includes the filter keyword, and no processing is performed on the network interaction data if the received network interaction data does not include the filter keyword. Then the network proxy server continues to determine whether a next pair of network interaction data includes the filter keyword. For example, the network proxy server obtains, from the received network interaction data between the terminal and the server by means of filtering, the following two pairs of network interaction data, when the filter keyword is “wd=” and stores the two pairs of network interaction data into the storage unit.

Network request 1:

http://www.baidu.com/s?wd=1&rsv_bp=0&tn=baidu&rsv_spt=3&ie=utf-8&rsv_enter=1&rsv_sug3=2&rsv_sug4=16&rsv_sug1=1&rsv_sug2=0&inputT=864&rsv_sug=2;

A corresponding response message also includes the filter keyword “wd=”, and the response message is not shown herein.

Network request 2:

http://suggestion.baidu.com/su?wd=&cb=window.bdsug.sugPreRequest&sid=4301_1425_4414_4261_4202_4450_4587&t=1387161319508;

Response message 2:

window.bdsug. sugPreRequest({ q:““,p:false,s: []}).

In this embodiment, if no filter keyword is set, no network interaction data is stored.

It should be noted that the web page test engineer may set the filter keyword at any time. For example, the filter keyword may be set when the network proxy server is enabled, or may be set after the network proxy server runs for a period of time. Only after receiving the filter keyword, the network proxy server performs filtering on the network interaction data, and replicates and saves the network interaction data that includes the filter keyword.

Step S1112: Obtain target network interaction data from the specified network interaction data.

The target network interaction data is network interaction data that includes a query keyword. The query keyword includes a character of the filter keyword.

The network test engineer may set the query keyword using the web page automated testing tool, and transfer the query keyword to the network proxy server through the open interface of the network proxy server.

The network proxy server determines whether the network interaction data that includes the query keyword exists in the specified network interaction data stored in the storage unit. If there exists the network interaction data that includes the query keyword, the network interaction data that includes the query keyword is fed back to the web page automated testing tool to obtain the target network interaction data. If there does not exist the network interaction data that includes the query keyword, null is returned to the web page automated testing tool. It can be learned from this that, the target network interaction data is partial network interaction data in the specified network interaction data.

The foregoing example is continued, and the network proxy server stores the two pairs of network interaction data that includes the filter keyword “wd=”. It is assumed that the query keyword is “wd=1”. If the network proxy server finds that the network request 1 and a response message 1 in the storage unit include “wd=1”, the network request 1 and the response message 1 are fed back to the web page automated testing tool.

In the method for obtaining target network interaction data provided in this embodiment, a filter keyword is set, and a network proxy server in a terminal obtains specified network interaction data from received network interaction data between the terminal and a server. Then a query keyword is set, and the network proxy server in the terminal obtains target network interaction data from the obtained specified network interaction data. In this way, a storage unit of the network proxy server needs to store only network interaction data that includes the filter keyword, which greatly saves storage space.

In another embodiment of the present disclosure, the terminal obtains, from obtained network interaction data, network interaction data that includes the query keyword in order to obtain the target network interaction data. That is, the terminal obtains the target network interaction data only using the query keyword.

In specific implementation, a network proxy server in a terminal obtains network interaction data between the terminal and a server, and replicates and stores the network interaction data into a storage unit, after receiving a query keyword transferred by a web page automated testing tool, obtains network interaction data that includes the query keyword from the storage unit, and sends the network interaction data to the web page automated testing tool such that the web page automated testing tool validates a network request and a corresponding response message that are in target network interaction data.

(2) The network proxy server is integrated on a server side.

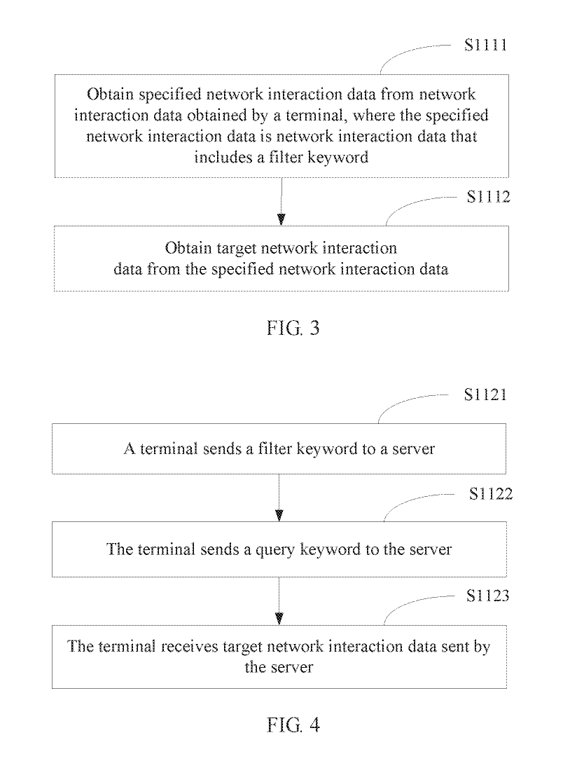

Referring to FIG. 4, FIG. 4 shows a schematic flowchart of another method for obtaining target network interaction data according to an embodiment of the present disclosure. This method is applied to a terminal, and this method is similar to that in the embodiment shown in FIG. 3. As shown in FIG. 4, the method may include the following steps.

Step S1121: The terminal sends a filter keyword to the server.

The filter keyword enables the server to obtain specified network interaction data from obtained network interaction data between the terminal and the server. The specified network interaction data is network interaction data that includes the filter keyword.

Step S1122: The terminal sends a query keyword to the server.

The query keyword enables the server to obtain target network interaction data from the specified network interaction data. The target network interaction data is network interaction data that includes the query keyword, and the query keyword includes at least a character of the filter keyword.

Step S1123: The terminal receives the target network interaction data sent by the server.

In all network interaction data between the terminal and the server, the network interaction data that includes the filter keyword is the specified network interaction data. In the specified network interaction data, the network interaction data that includes the query keyword is the target network interaction data. The target network interaction data is network interaction data that needs to be validated by a web page automated testing tool. Therefore, only the target network interaction data needs to be sent to the terminal, and the specified network interaction data does not need to be sent to the terminal.

In the method for obtaining target network interaction data provided in this embodiment, a terminal transfers a filter keyword to a server such that the server obtains only specified network interaction data from received network interaction data between the terminal and the server. Then, the terminal transfers a query keyword to the server, and the server obtains target network interaction data from the obtained specified network interaction data. In this way, only the specified network interaction data needs to be stored on a server side, which greatly saves storage space.

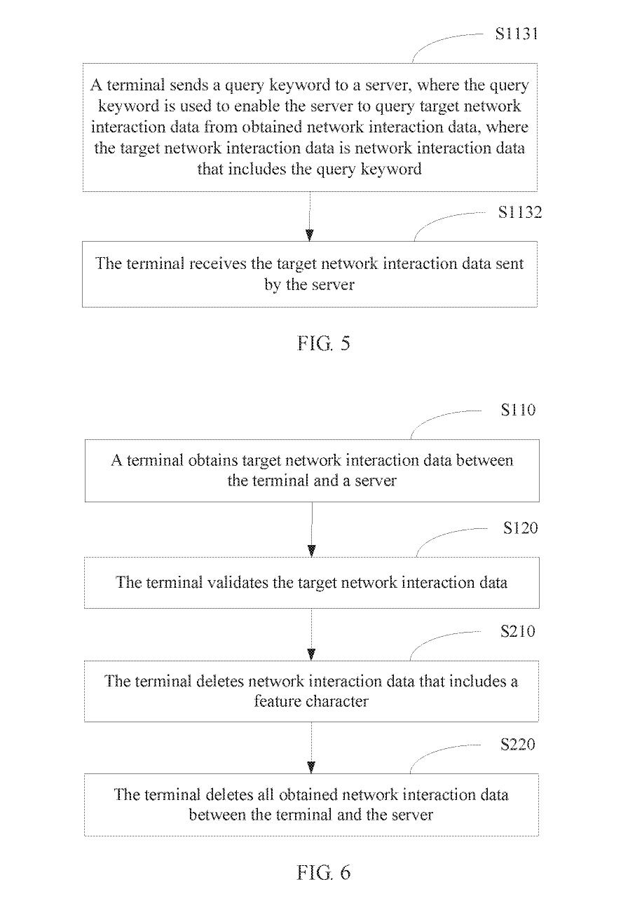

In another embodiment of the present disclosure, only a query keyword is set. A network proxy server in a server obtains target network interaction data by performing filtering on received network interaction data between the server and the terminal. The target network interaction data is network interaction data that includes the query keyword. As shown in FIG. 5, a method for obtaining target network interaction data includes the following steps.

Step S1131: The terminal sends a query keyword to the server. The query keyword is used to enable the server to query target network interaction data from obtained network interaction data, where the target network interaction data is network interaction data that includes the query keyword.

Step S1132: The terminal receives the target network interaction data sent by the server.

In the method for obtaining target network interaction data provided in this embodiment, a terminal transfers a query keyword to a server such that the server obtains, from network interaction data between the terminal and the server, network interaction data that includes the query keyword, and feeds back the network interaction data that includes the query keyword to the terminal.

Referring to FIG. 6, FIG. 6 shows a schematic flowchart of another web page automated testing method according to an embodiment of the present disclosure. This method is applied to a terminal, and on the basis of the embodiment shown in FIG. 2, the method may further include steps S210 and S220. Steps S110 and S120 in FIG. 6 are the same as steps S110 and S120 shown in FIG. 2, and are not described herein again.

Step S210: The terminal deletes network interaction data that includes a feature character.

In specific implementation, if a network proxy server is integrated into the terminal, a web page automated testing tool in the terminal sends a delete instruction to the network proxy server in the terminal through an open interface. The delete instruction includes the feature character. The network proxy server deletes the network interaction data that includes the feature character when receiving the delete instruction.

The feature character may be any segment of character string in a network request or a response message. For example, when the web page automated testing tool repeatedly performs a completely same operation twice on a browser or a web page, and needs to validate network interaction data generated during the second operation, before performing the second operation, the web page automated testing tool needs to delete a network request and a response message generated during the first operation.

Step S220: The terminal deletes all obtained network interaction data between the terminal and the server.

If the network proxy server is integrated into the terminal, the web page automated testing tool in the terminal sends an empty instruction to the network proxy server through the open interface. After receiving the empty instruction, the network proxy server empties all network interaction data stored in a storage unit in order to save storage space.

An execution sequence of steps S210 and S220 is not strictly limited. Step S220 may be first performed and then step S210 provided that steps S210 and S220 are performed after the network proxy server stores the network interaction data.

In the web page automated testing method provided in this embodiment, network interaction data that has been stored in a network proxy server of a terminal and includes a feature character can be deleted, and all stored network interaction data can be emptied, thereby saving storage space of the network proxy server.

Corresponding to the foregoing embodiments of the web page automated testing method applied to the terminal, if the network proxy server is integrated into the server, the present disclosure further provides an embodiment of a web page automated testing method applied to a server side.

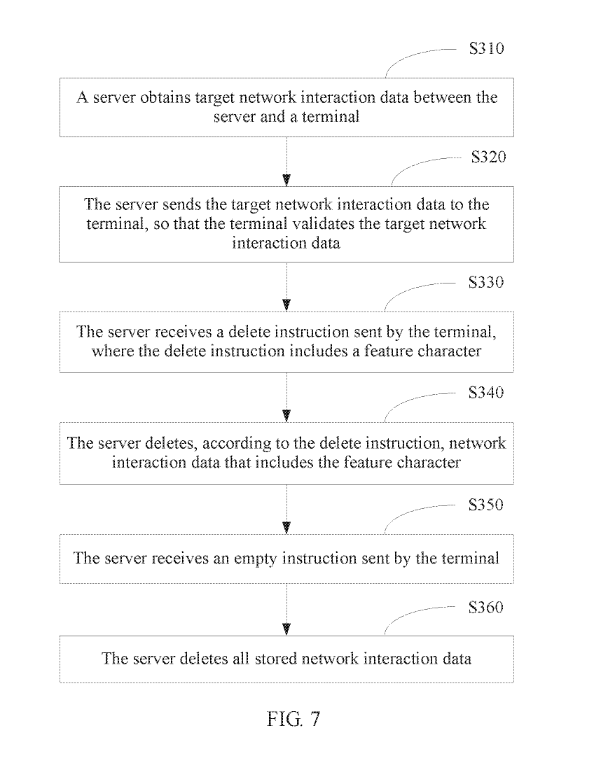

Referring to FIG. 7, FIG. 7 shows a schematic flowchart of another web page automated testing method according to an embodiment of the present disclosure. This method is applied to a server. As shown in FIG. 7, the method includes the following steps.

Step S310: The server obtains target network interaction data between the server and a terminal.

The target network interaction data includes a network request that is received by the server and is sent by the terminal, and a response message sent by the server to the terminal. The response message is a response of the server to the network request sent by the terminal.

Step S310 may be implemented in the following two manners.

(1) The first implementation manner of step S310:

Step 1: The server receives a query keyword sent by the terminal.

Step 2: The server obtains the target network interaction data from obtained network interaction data between the server and the terminal, where the target network interaction data is network interaction data that includes the query keyword.

The query keyword is set on a terminal side. The server obtains, from the obtained network interaction data between the server and the terminal by means of filtering, the network interaction data that includes the query keyword.

(2) The second implementation manner of step S310:

Step 11: The server receives a filter keyword sent by the terminal.

Step 12: The server obtains specified network interaction data from obtained network interaction data between the server and the terminal, where the specified network interaction data is network interaction data that includes the filter keyword.

Step 13: The server receives a query keyword sent by the terminal, where the query keyword includes a character of the filter keyword.

Step 14: The server obtains the target network interaction data from the specified network interaction data. The target network interaction data is network interaction data that includes the query keyword.

Step S320: The server sends the target network interaction data to the terminal such that the terminal validates the target network interaction data.

In the web page automated testing method provided in this embodiment, a server obtains target network interaction data between the server and a terminal, and then sends the target network interaction data to the terminal such that the terminal validates the target network interaction data, thereby implementing validation on a web page or a browser.

Preferably, as shown in FIG. 7, the method may further include the following steps.

Step S330: The server receives a delete instruction sent by the terminal, where the delete instruction includes a feature character.

Step S340: The server deletes, according to the delete instruction, network interaction data that includes the feature character.

Step S350: The server receives an empty instruction sent by the terminal.

Step S360: The server deletes all stored network interaction data.

A server provided in this embodiment obtains, using a network proxy server, specified network interaction data sent by a browser to the server, obtains target network interaction data from the specified network interaction data, and provides the target network interaction data for a web page automated testing tool. The web page automated testing tool validates the target network interaction data, thereby implementing validation on network interaction data between the browser or a web page and the server in order to improve a capability of testing a web page defect.

The foregoing method embodiments applied to a network proxy server and the method embodiments applied to a web page automated testing tool may be all integrated into the web page automated testing tool for implementation, or may be separately and independently implemented.

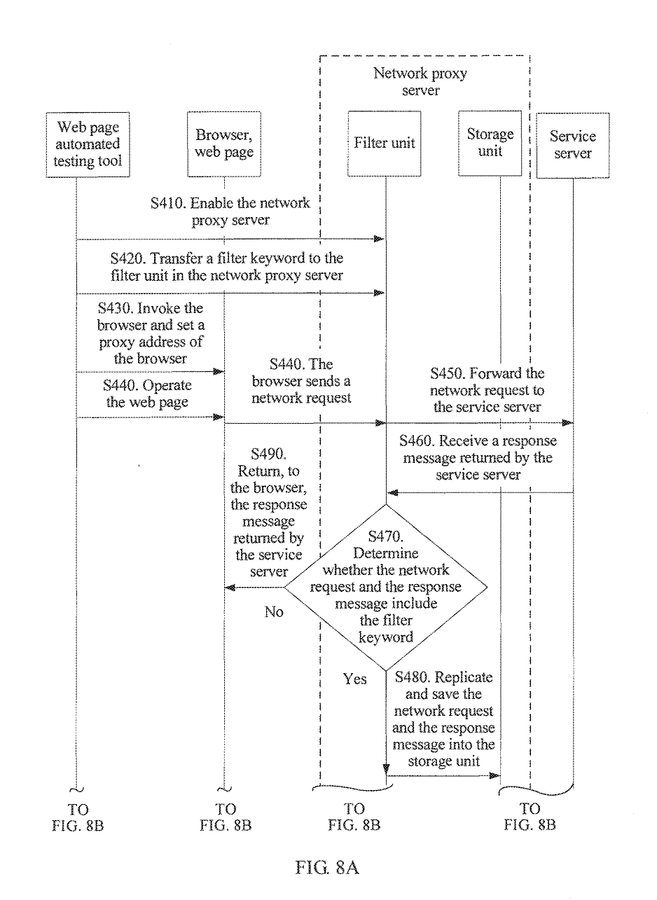

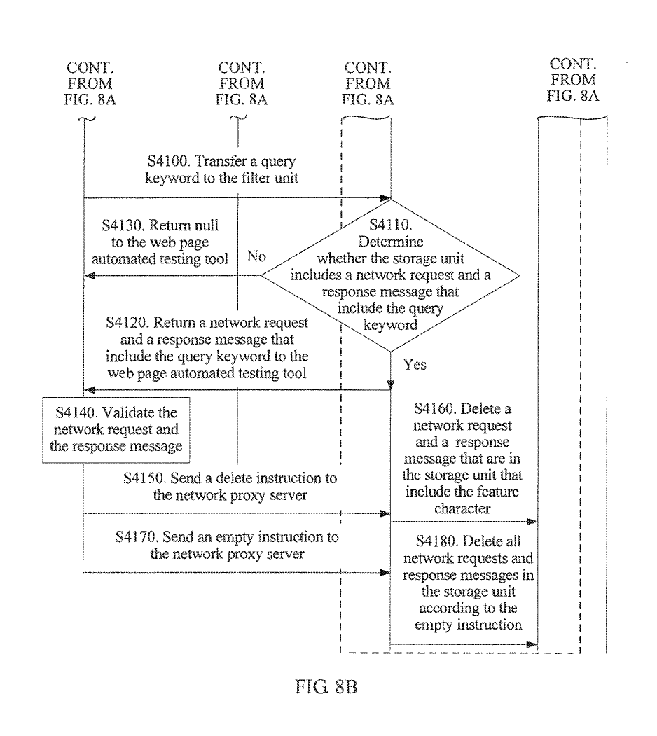

Referring to FIG. 8A and FIG. 8B, FIG. 8A and FIG. 8B are a schematic flowchart of a web page automated testing method. As shown in FIG. 8A and FIG. 8B, the method includes the following steps.

Step S410: A web page automated testing tool enables a network proxy server.

The web page automated testing tool is integrated into a terminal. If the network proxy server is integrated into the web page automated testing tool in the terminal, the web page automated testing tool initializes the network proxy server, and the web page automated testing tool enables the network proxy server using a command if the network proxy server is integrated into a server.

Step S420: The web page automated testing tool transfers a filter keyword to a filter unit in the network proxy server. For example, the filter keyword is “wd=”.

Step S430: The web page automated testing tool invokes a browser and sets a proxy address of the browser.

Step S440: The web page automated testing tool operates a web page so that the browser sends a network request.

For example, when the web page automated testing tool opens a web page “http://www.baidu.com” in the browser, and searches for “1” using the search engine BAIDU, the browser sends a network request, receives a response message returned by the server, and displays a search result page.

Step S450: The network proxy server receives the network request and forwards the network request to service server.

Step S460: The network proxy server receives a response message returned by the service server, where the response message is a response of the server to the network request sent by the terminal.

Step S470: The network proxy server determines whether the network request and the response message include the filter keyword, if the network request and the response message include the filter keyword, step S480 is performed, and if the network request and the response message do not include the filter keyword, step S490 is performed.

Step S480: The network proxy server replicates the network request and the response message, and saves the network request and the response message into a storage unit.

Step S490: The network proxy server returns, to the browser, the response message returned by the service server.

Step S4100: The web page automated testing tool transfers a query keyword to the filter unit. For example, the query keyword is “wd=1”.

Step S4110: The filter unit determines whether the storage unit includes a network request and a response message that include the query keyword, if the storage unit includes a network request and a response message that include the query keyword, step S4120 is performed, and if the storage unit does not include a network request and a response message that include the query keyword, step S4130 is performed, where network interaction data that includes “wd=1” is obtained by filtering from stored network interaction data.

Step S4120: Return the network request and the response message that include the query keyword to the web page automated testing tool.

If the storage unit includes multiple pairs of network requests and response messages that include the query keyword, only the first pair of network request and response message that include the query keyword is returned.

Step S4130: Return null to the web page automated testing tool.

Step S4140: The web page automated testing tool validates the received network request and response message.

Then, steps S440-S4140 are repeatedly performed to validate multiple pairs of network requests and response messages.

Step S4150: The web page automated testing tool sends a delete instruction to the network proxy server. The delete instruction includes a feature character.

Step S4160: The network proxy server deletes, according to the delete instruction, a network request and a corresponding response message that include the feature character.

Step S4170: The web page automated testing tool sends an empty instruction to the network proxy server.

Step S4180: The network proxy server deletes all network requests and response messages in the storage unit according to the empty instruction.

Corresponding to the foregoing web page automated testing method embodiments, the present disclosure further provides a web page automated testing apparatus.

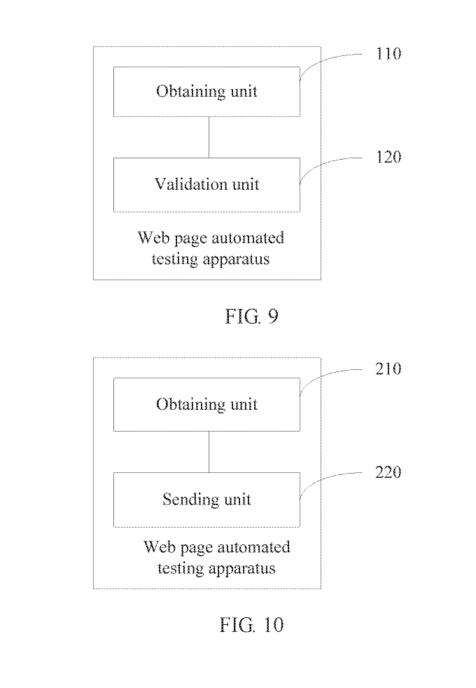

Referring to FIG. 9, FIG. 9 shows a schematic structural diagram of a web page automated testing apparatus according to an embodiment of the present disclosure. This apparatus is applied to a terminal. As shown in FIG. 9, the apparatus includes an obtaining unit 110 and a validation unit 120.

The obtaining unit 110 is configured to obtain target network interaction data between the terminal and a server.

In this embodiment of the present disclosure, network interaction data between the terminal and the server may be obtained using a network proxy server.

The target network interaction data includes a network request sent by the terminal to the server, and a response message that is received by the terminal and is returned by the server. The response message is a response of the server to the network request sent by the terminal.

In an embodiment of the present disclosure, the network proxy server is integrated into the terminal, and the obtaining unit 110 may include a first obtaining subunit (not shown) and a second obtaining subunit (not shown).

The first obtaining subunit is configured to obtain specified network interaction data from obtained network interaction data between the terminal and the server. The specified network interaction data is network interaction data that includes a filter keyword.

The second obtaining subunit is configured to obtain, from the specified network interaction data obtained by the first obtaining subunit, network interaction data that includes a query keyword in order to obtain the target network interaction data. The query keyword includes a character of the filter keyword.

In another embodiment of the present disclosure, the network proxy server is integrated into the terminal, and the obtaining unit 110 includes a third obtaining subunit (not shown).

The third obtaining subunit is configured to obtain, from obtained network interaction data between the terminal and the server, network interaction data that includes the query keyword in order to obtain the target network interaction data.

In still another embodiment of the present disclosure, the network proxy server is integrated on a server side, and the obtaining unit 110 includes a sending subunit (not shown) and a receiving subunit (not shown).

The sending subunit is configured to send a filter keyword to the server. The filter keyword enables the server to obtain specified network interaction data from obtained network interaction data between the terminal and the server. The specified network interaction data is network interaction data that includes the filter keyword.

The sending subunit is further configured to send a query keyword to the server. The query keyword enables the server to obtain the target network interaction data from the specified network interaction data. The target network interaction data is network interaction data that includes the query keyword, and the query keyword includes at least a character of the filter keyword.

The receiving subunit is configured to receive the target network interaction data sent by the server.

In yet another embodiment of the present disclosure, the network proxy server is integrated into the server, and the obtaining unit 110 includes a sending subunit (not shown) and a receiving subunit (not shown).

The sending subunit is configured to send a query keyword to the server. The query keyword enables the server to obtain the target network interaction data from obtained network interaction data between the terminal and the server. The target network interaction data is network interaction data that includes the query keyword.

The receiving subunit is configured to receive the target network interaction data sent by the server.

The validation unit 120 is configured to validate the target network interaction data obtained by the obtaining unit 110.

The web page automated testing apparatus provided in this embodiment obtains target network interaction data between the terminal and a server using an obtaining unit 110. Then validates a network request in the target network interaction data using a validation unit 120, which improves a capability of finding a web page defect, and validates a response message returned by the server, which improves accuracy of a web page display validation result.

Corresponding to the foregoing web page automated testing method embodiment applied to the server, an embodiment of the present disclosure further provides a web page automated testing apparatus embodiment applied to the server.

Referring to FIG. 10, FIG. 10 shows a schematic structural diagram of another web page automated testing apparatus according to an embodiment of the present disclosure. This apparatus is applied to a server. The apparatus includes an obtaining unit 210 and a sending unit 220.

The obtaining unit 210 is configured to obtain target network interaction data between the server and a terminal.

The target network interaction data includes a network request that is received by the server and is sent by the terminal, and a response message sent by the server to the terminal. The response message is a response of the server to the network request sent by the terminal.

In an embodiment of the present disclosure, the obtaining unit 210 may include a receiving subunit (not shown) and an obtaining subunit (not shown).

The receiving subunit is configured to receive a query keyword sent by the terminal.

The obtaining subunit is configured to obtain the target network interaction data from obtained network interaction data between the server and the terminal, where the target network interaction data is network interaction data that includes the query keyword.

In another embodiment of the present disclosure, the obtaining unit 210 may include a receiving subunit (not shown) and an obtaining subunit (not shown).

The receiving subunit is configured to receive a filter keyword sent by the terminal.

The obtaining subunit is configured to obtain specified network interaction data from obtained network interaction data between the server and the terminal, where the specified network interaction data is network interaction data that includes the filter keyword received by the receiving subunit.

The receiving subunit is further configured to receive a query keyword sent by the terminal, where the query keyword includes a character of the filter keyword.

The obtaining subunit is further configured to obtain the target network interaction data from the specified network interaction data. The target network interaction data is network interaction data that includes the query keyword received by the receiving subunit.

The sending unit 220 is configured to send the target network interaction data obtained by the obtaining unit 210 to the terminal, where the target network interaction data is used by the terminal to validate the target network interaction data.

Corresponding to the foregoing web page automated testing apparatus embodiment, the present disclosure further provides a terminal, where the terminal includes a processor.

The processor is configured to obtain target network interaction data between the terminal and a server, and validate the target network interaction data.

The target network interaction data includes a network request sent by the terminal to the server, and a response message that is received by the terminal and is returned by the server. The response message is a response of the server to the network request sent by the terminal.

In an embodiment of the present disclosure, the processor is further configured to obtain specified network interaction data from network interaction data that is obtained by the terminal and is between the terminal and the server. The specified network interaction data is network interaction data that includes a filter keyword, and obtain, from the specified network interaction data, network interaction data that includes a query keyword in order to obtain the target network interaction data, where the query keyword includes a character of the filter keyword.

In another embodiment of the present disclosure, the processor is further configured to obtain, from network interaction data that is obtained by the terminal and is between the terminal and the server, network interaction data that includes the query keyword in order to obtain the target network interaction data.

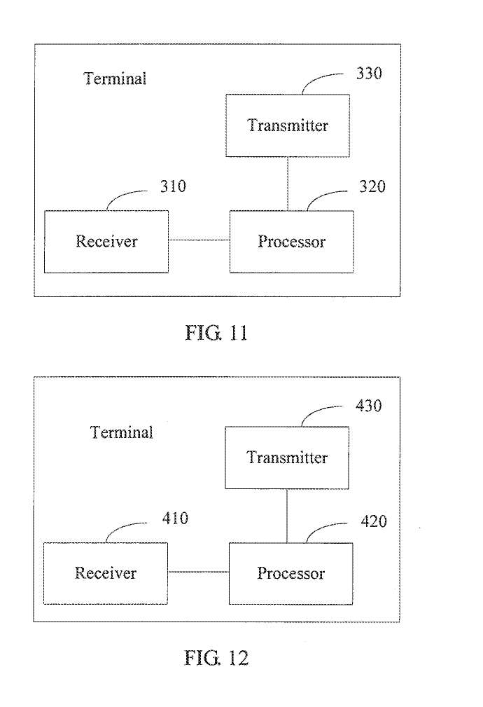

Referring to FIG. 11, FIG. 11 shows a schematic structural diagram of another terminal according to an embodiment of the present disclosure. The terminal is integrated with a web page automated testing tool. As shown in FIG. 11, the terminal includes a transmitter 330, a processor 320, and a receiver 310. The transmitter 330 is connected to the processor 320, and the receiver 310 is connected to the processor 320.

The transmitter 330 is configured to send a filter keyword to the server. The filter keyword enables the server to obtain specified network interaction data from obtained network interaction data between the terminal and the server. The specified network interaction data is network interaction data that includes the filter keyword.

The server is integrated with a network proxy server, and obtains the network interaction data between the terminal and the server using the network proxy server.

The transmitter 330 is further configured to send a query keyword to the server. The query keyword enables the server to obtain target network interaction data from the specified network interaction data. The target network interaction data is network interaction data that includes the query keyword, and the query keyword includes at least a character of the filter keyword.

The receiver 310 is configured to receive the target network interaction data sent by the server.

The processor 320 is configured to validate the target network interaction data received by the receiver 310.

Referring to FIG. 12, FIG. 12 shows a schematic structural diagram of still another terminal according to an embodiment of the present disclosure. As shown in FIG. 12, the terminal includes a transmitter 430, a processor 420, and a receiver 410, where the transmitter 430 is connected to the processor 420, and the receiver 410 is connected to the processor 420.

The transmitter 430 is configured to send a query keyword to the server. The query keyword enables the server to obtain target network interaction data from obtained network interaction data between the terminal and the server. The target network interaction data is network interaction data that includes the query keyword.

The receiver 410 is configured to receive the target network interaction data sent by the server.

The processor 420 is configured to validate the target network interaction data received by the receiver 410.

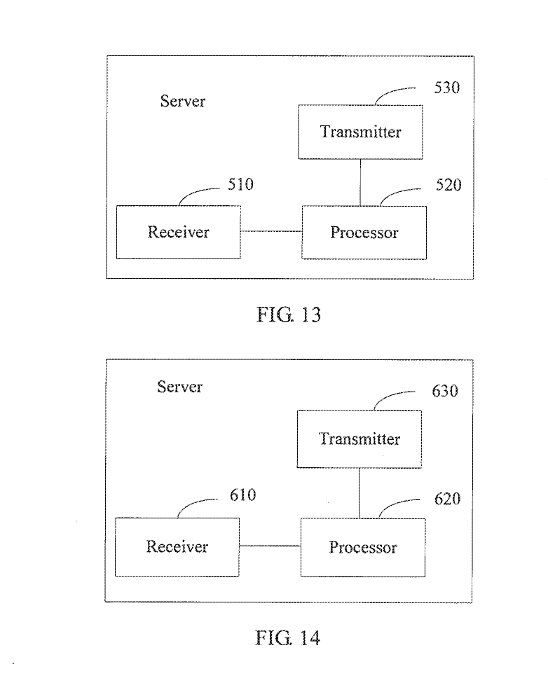

Corresponding to the foregoing terminal embodiment, the present disclosure further provides a server. As shown in FIG. 13, the server includes a receiver 510, a processor 520, and a transmitter 530, where the transmitter 530 is connected to the processor 520, and the receiver 510 is connected to the processor 520.

The receiver 510 is configured to receive a query keyword sent by a terminal.

The processor 520 is configured to obtain target network interaction data from obtained network interaction data between the server and the terminal.

The target network interaction data is network interaction data that includes the query keyword. The target network interaction data includes a network request that is received by the server and is sent by the terminal, and a response message sent by the server to the terminal. The response message is a response of the server to the network request sent by the terminal.

The transmitter 530 is configured to send the target network interaction data obtained by the processor 520 to the terminal such that the terminal validates the target network interaction data.

The server provided in this embodiment receives, a query keyword set by a terminal, obtains, from network interaction data between the terminal and the server using an internal integrated network proxy server, target network interaction data that includes the query keyword, and sends the target network interaction data to the terminal. The terminal validates the target network interaction data. This implements validation on network interaction data between a web page or a browser and the server, thereby improving a testing capability of a web page automated testing tool.

Referring to FIG. 14, FIG. 14 shows a schematic structural diagram of another server according to an embodiment of the present disclosure. The server is integrated with a network proxy server. As shown in FIG. 14, the server includes a receiver 610, a processor 620, and a transmitter 630. The transmitter 630 is connected to the processor 620, and the receiver 610 is connected to the processor 620.

The receiver 610 is configured to receive a filter keyword sent by the terminal.

The processor 620 is configured to obtain specified network interaction data from obtained network interaction data between the server and the terminal.

The specified network interaction data is network interaction data that includes the filter keyword.

The receiver 610 is further configured to receive a query keyword sent by the terminal.

The query keyword includes a character of the filter keyword.

The processor 620 is further configured to obtain target network interaction data from the specified network interaction data. The target network interaction data is network interaction data that includes the query keyword received by the receiver 610.

The transmitter 630 is configured to send the target network interaction data obtained by the processor 620 to the terminal, where the target network interaction data is used by the terminal to validate the target network interaction data.

The server provided in this embodiment receives, a filter keyword sent by a terminal, obtains, using an internal integrated network proxy server, specified network interaction data that includes the filter keyword, then receives, using the receiver, a query keyword sent by the terminal, obtains, from the specified network interaction data using the network proxy server, target network interaction data that includes the query keyword, and sends the target network interaction data to the terminal. The terminal validates the target network interaction data. This implements validation on network interaction data between a web page or a browser and the server, thereby improving a testing capability of a web page automated testing tool.

In another aspect, an embodiment of the present disclosure further provides a computer storage medium, where the computer storage medium may store a program, and the program may execute the method embodiments shown in FIG. 2-FIG. 6.

In still another aspect, an embodiment of the present disclosure further provides a computer storage medium, where the computer storage medium may store a program, and the program may execute the method embodiment shown in FIG. 7.

The embodiments in this specification are all described in a progressive manner, for same or similar parts in the embodiments, reference may be made to these embodiments, and each embodiment focuses on a difference from other embodiments. Especially, apparatus or system embodiments are basically similar to a method embodiment, and therefore are described briefly. For related parts, reference may be made to partial descriptions in the method embodiment. The described apparatus and system embodiments are merely examples. The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments. A person of ordinary skill in the art may understand and implement the embodiments of the present disclosure without creative efforts.

The present disclosure can be described in the general context of executable computer instructions executed by a computer, for example, a program module. Generally, the program unit includes a routine, program, object, component, data structure, and the like for executing a particular task or implementing a particular abstract data type. The present disclosure may also be practiced in distributed computing environments in which tasks are performed by remote processing devices that are connected using a communications network. In a distributed computing environment, program modules may be located in both local and remote computer storage media including storage devices.

It should be noted that in this specification, relational terms such as “first” and “second” are only used to distinguish one entity or operation from another, and do not necessarily require or imply that any actual relationship or sequence exists between these entities or operations. Moreover, the terms “include,” “include,” or their any other variant is intended to cover a non-exclusive inclusion such that a process, a method, an article, or a device that includes a list of elements not only includes those elements but also includes other elements that are not expressly listed, or further includes elements inherent to such a process, method, article, or device. An element preceded by “includes a . . . ” does not, without more constraints, preclude the presence of additional identical elements in the process, method, article, or device that includes the element.

The foregoing descriptions are merely specific implementation manners of the present disclosure. It should be noted that a person of ordinary skill in the art may make several improvements or polishing without departing from the principle of the present disclosure and the improvements or polishing shall fall within the protection scope of the present disclosure.

1.-26. (canceled)

27. A web page automated testing method, comprising:
obtaining, by a terminal, target network interaction data between the terminal and a server, wherein the target network interaction data comprises a network request sent by the terminal to the server, and a response message that is received by the terminal and is returned by the server, and wherein the response message is a response of the server to the network request sent by the terminal; and
validating, by the terminal, the target network interaction data.

28. The method according to claim 27, wherein obtaining the target network interaction data comprises:
obtaining, by the terminal, specified network interaction data from network interaction data that is obtained by the terminal and is between the terminal and the server, wherein the specified network interaction data is network interaction data that comprises a filter keyword; and
obtaining, by the terminal from the specified network interaction data, network interaction data that comprises a query keyword in order to obtain the target network interaction data, wherein the query keyword comprises a character of the filter keyword.

29. The method according to claim 27, wherein obtaining the target network interaction data comprises obtaining, by the terminal from network interaction data that is obtained by the terminal and is between the terminal and the server, network interaction data that comprises a query keyword in order to obtain the target network interaction data.

30. The method according to claim 27, Wherein obtaining the target network interaction data comprises:
sending, by the terminal, a filter keyword to the server, wherein the filter keyword enables the server to obtain specified network interaction data from obtained network interaction data between the terminal and the server, and wherein the specified network interaction data is network interaction data that comprises the filter keyword;
sending, by the terminal, a query keyword to the server, wherein the query keyword enables the server to obtain the target network interaction data from the specified network interaction data, wherein the target network interaction data is network interaction data that comprises the query keyword, and wherein the query keyword comprises at least a character of the filter keyword; and
receiving, by the terminal, the target network interaction data sent by the server.

31. The method according to claim 27, wherein obtaining the target network interaction data comprises:
sending, by the terminal, a query keyword to the server, wherein the query keyword enables the server to obtain the target network interaction data from obtained network interaction data between the terminal and the server, and wherein the target network interaction data is network interaction data that comprises the query keyword; and
receiving, by the terminal, the target network interaction data sent by the server.

32. A web page automated testing method, comprising:
obtaining, by a server, target network interaction data between the server and a terminal, wherein the target network interaction data comprises a network request that is received by the server and is sent by the terminal, and a response message sent by the server to the terminal, and wherein the response message is a response of the server to the network request sent by the terminal; and
sending, by the server, the target network interaction data to the terminal, wherein the target network interaction data is used by the terminal to validate the target network interaction data.

33. The method according to claim 32, wherein obtaining the target network interaction data comprises:
receiving, by the server, a query keyword sent by the terminal; and
obtaining, by the server, the target network interaction data from obtained network interaction data between the server and the terminal, wherein the target network interaction data is network interaction data that comprises the query keyword.

34. The method according to claim 32, wherein obtaining the target network interaction data comprises:
receiving, by the server, a filter keyword sent by the terminal;
obtaining, by the server, specified network interaction data from obtained network interaction data between the server and the terminal, wherein the specified network interaction data is network interaction data that comprises the filter keyword;
receiving, by the server, a query keyword sent by the terminal, wherein the query keyword comprises a character of the filter keyword; and
obtaining, by the server, the target network interaction data from the specified network interaction data, wherein the target network interaction data is network interaction data that comprises the query keyword.

35. A terminal, comprising:
a memory; and
a processor coupled to the memory and configured to:
obtain target network interaction data between the terminal and a server, wherein the target network interaction data comprises a network request sent by the terminal to the server, and a response message that is received by the terminal and is returned by the server, and wherein the response message is a response of the server to the network request sent by the terminal; and
validate the target network interaction data.

36. The terminal according to claim 35, wherein the processor is further configured to:
obtain specified network interaction data from network interaction data that is obtained by the terminal and is between the terminal and the server, wherein the specified network interaction data is network interaction data that comprises a filter keyword; and
obtain, from the specified network interaction data, network interaction data that comprises a query keyword in order to obtain the target network interaction data, wherein the query keyword comprises a character of the filter keyword.

37. The terminal according to claim 35, wherein the processor is further configured to obtain, from network interaction data that is obtained by the terminal and is between the terminal and the server, network interaction data that comprises a query keyword in order to obtain the target network interaction data.

38. The terminal according to claim 35, further comprising a transmitter connected to the processor and configured to:
send a filter keyword to the server, wherein the filter keyword enables the server to obtain specified network interaction data from obtained network interaction data between the terminal and the server, and wherein the specified network interaction data is network interaction data that comprises the filter keyword;
send a query keyword to the server, wherein the query keyword enables the server to obtain the target network interaction data from the specified network interaction data, wherein the target network interaction data is network interaction data that comprises the query keyword, and wherein the query keyword comprises at least a character of the filter keyword, and wherein the terminal further comprises a receiver connected to the processor and configured to:
receive the target network interaction data sent by the server; and
send the target network interaction data to the processor.

39. The to a according to claim 35, further comprising a transmitter connected to the processor and configured to send a query keyword to the server, wherein the query keyword enables the server to obtain the target network interaction data from obtained network interaction data between the terminal and the server, wherein the target network interaction data is network interaction data that comprises the query keyword, and wherein the terminal further comprises a receiver connected to the processor and configured to:
receive the target network interaction data sent by the server; and
provide the target network interaction data for the processor.
